(19) United States
(12) Patent Application Publication
(10) Pub. No.: US 2021/0390343 A1
(43) Pub. Date: Dec. 16, 2021

(54) BACKPROPAGATION-ENABLED METHOD FOR IDENTIFYING A SEA SURFACE ANOMALY FROM SATELLITE-ACQUIRED IMAGES AND/OR AIRBORNE-ACQUIRED IMAGES

(71) Applicant: SHELL OIL COMPANY, HOUSTON, TX (US)

(72) Inventors: David A. LAVALLEE, Houston, TX (US); Russell David POTTER, Houston, TX (US); Stephen Edward KEEDWELL, Rijswijk (NL); Oliver MUELLENHOFF, Rijswijk (NL); Benjamin Thomas KING, Houston, TX (US)

(21) Appl. No.: 17/287,562

(22) PCT Filed: Oct. 23, 2019
(86) PCT No.: PCT/US2019/057608

§ 371 Date: Apr. 22, 2021

Related U.S. Application Data
(60) Provisional application No. 62/750,569, filed on Oct. 25, 2018.

(51) Int. Cl. G06K 9/62; G06T 7/70; G06T 7/10

(52) U.S. Cl. CPC G06K 9/6256; G06T 7/70; G06T 7/10; G06T 2207/30181; G06T 2207/10032; G06T 2207/20084; G06T 2207/20081; G06K 9/6267

(57) ABSTRACT

A backpropagation-enabled method for identifying a sea surface anomaly involves collecting an initial set of images and labeling the anomaly on the initial set of images. The initial set of images are selected from satellite-acquired images and/or simulated satellite images. The labels are used to train a model via backpropagation. A subsequent set of images, including satellite-acquired, airborne-acquired images, and combinations thereof, is collected and the trained model is applied to identify a sea surface anomaly on the subsequent set of images.

### FIELD OF THE INVENTION

The present invention relates to the field of identifying sea surface anomalies from satellite-acquired and/or airborne-acquired imagery, by means of a backpropagation-enabled method for identifying the sea surface anomalies.

### BACKGROUND OF THE INVENTION

Certain conditions on or near the sea surface create anomalies that can be captured by satellite images. However, there remains a need for a method to efficiently scan satellite images to identify and locate the sea surface anomaly.

The sea surface around the globe is immense, as is the availability of satellite images. Often, satellite images are reviewed for a targeted area to observe changes in the sea surface. But, it is difficult to find sea surface anomalies over vast areas.

CN105630882 relates to an offshore contaminants recognition and tracking system. The system is divided into an application layer, a content analysis and mining layer, a data integration layer resources, resource acquisition layer, comprising pollutants target identification, decision support subsystems, alarm subsystems, pollutants drift forecast subsystem, all kinds of pollution and the chemical composition of product hazards database, clean-up relief material/equipment performance and inventory database, geographic information systems, pollution emergency response capacity evaluation subsystem, subsystems pollution damage assessment can be combined with wireless communication systems technology for emergency response, visual information communication between the aircraft and Coast Guard vessels operating at sea and, according to the report of Coast Guard aircraft, rescue quickly generate, Clear program, directing clean-up boats were a number of clean-up operations integrated marine clean-up technology, quickly and accurately.

There is a need for a backpropagation-enabled method for identifying a sea surface anomaly from satellite-acquired and/or airborne images.

### SUMMARY OF THE INVENTION

According to one aspect of the present invention, there is provided a backpropagation-enabled method for identifying a sea surface anomaly from satellite-acquired images, airborne images and combinations thereof, comprising the steps of collecting an initial set of images selected from the group consisting of satellite-acquired images, simulated satellite images, and combinations thereof; labeling the anomaly on the initial set of images; using the labels to train a model via backpropagation; collecting a subsequent set of images selected from the group consisting of satellite-acquired, airborne images, and combinations thereof; and applying the trained model to identify a sea surface anomaly on the subsequent set of images.

### BRIEF DESCRIPTION OF THE DRAWINGS

The present invention will be better understood by referring to the following detailed description of preferred embodiments and the drawings referenced therein, in which:

FIG. 1A illustrates one embodiment of a step of collecting an initial set of satellite images for the method of the present invention;

FIG. 1B illustrates one embodiment of a step of collecting an initial set of simulated satellite images for the method of the present invention;

FIGS. 2A-2D illustrate embodiments of a step of labeling a sea surface anomaly on an initial set of satellite images for the method of the present invention;

FIG. 3 illustrates one embodiment of a step of using labels to train via backpropagation for the method of the present invention;

FIG. 4A illustrates one embodiment of a step of collecting a subsequent set of satellite images for the method of the present invention;

FIGS. 4B-4C illustrate further embodiments of a step of collecting a subsequent set of airborne images for the method of the present invention; and

FIG. 5 illustrates one embodiment of a step of using the trained model to identify a sea surface anomaly in the method of the present invention.

### DETAILED DESCRIPTION OF THE INVENTION

The method of the present invention trains a model for identifying a sea surface anomaly from satellite-acquired images, airborne-acquired images and a combination thereof. The method of the present invention can identify sea surface anomalies from a set of unlabeled images.

A sea surface anomaly is a deviation in the sea surface relative to the surrounding sea surface, including, for example, without limitation, a wave-damping effect, an optical anomaly, and the like. An example of an optical anomaly is a sheen. Various factors may cause the sea surface anomaly. Substances or structures that may cause a sea surface anomaly include, for example, without limitation, a man-made object, a debris path, a natural or man-made fluid, an underlying formation, such as a coral reef, the presence of hydrocarbons, and the like. Hydrocarbons on a sea surface cause a wave-damping effect and/or a sheen effect that is different from the surrounding sea surface.

In a preferred embodiment of the present invention, the sea surface anomaly is caused by the presence of hydrocarbons, including, for example, without limitation, crude oil and/or refined hydrocarbons. The anomaly may be caused by hydrocarbon seepage from the subsurface, for example, from a natural seepage or from a seepage caused by a man-made action. The anomaly may also be caused by a leak of uncontained hydrocarbons from a man-made facility. The leak may be the direct and/or indirect result of a human action.

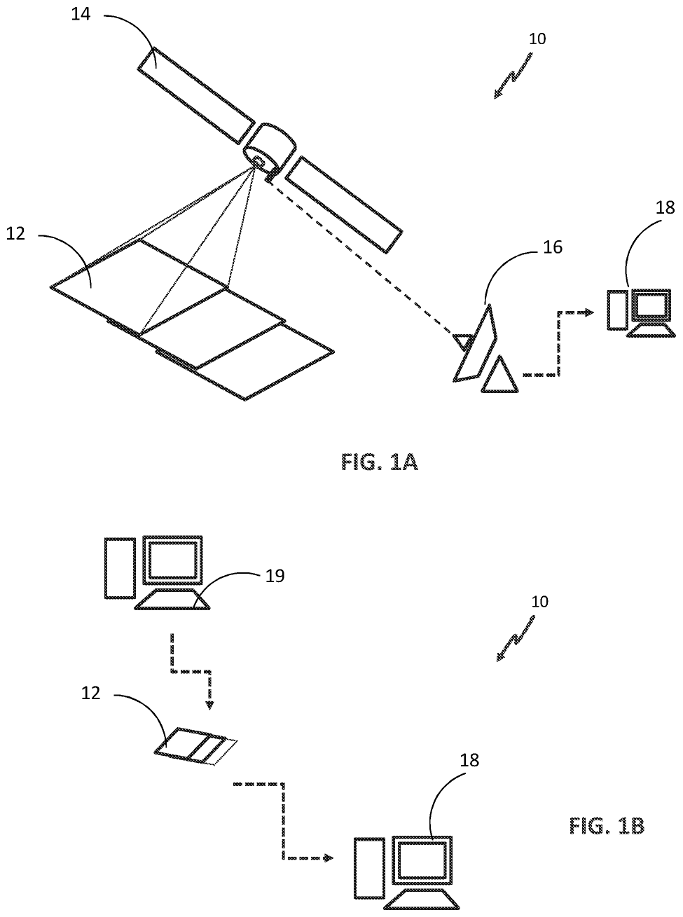

Referring now to FIG. 1A and FIG. 1B, as embodiments of a first step of the method of the present invention 10, an initial set of images 12 are collected. The initial set of images 12 may be satellite-acquired images and/or simulated satellite images. In the embodiment illustrated in FIG. 1A, the images are acquired from a satellite 14 and transmitted through a satellite receiver 16 to a processor 18, depicted generally in FIG. 1A by a desk-top computer. In the embodiment illustrated in FIG. 1B, the images are simulated satellite images produced by a computer 19 and transmitted to a processor 18, depicted generally in FIG. 1B by a desk-top computer. It will be understood by those skilled in the art that the processor 18 may take other forms than a desk-top computer. In a further embodiment, the simulated satellite images may be produced at the same processor 18.

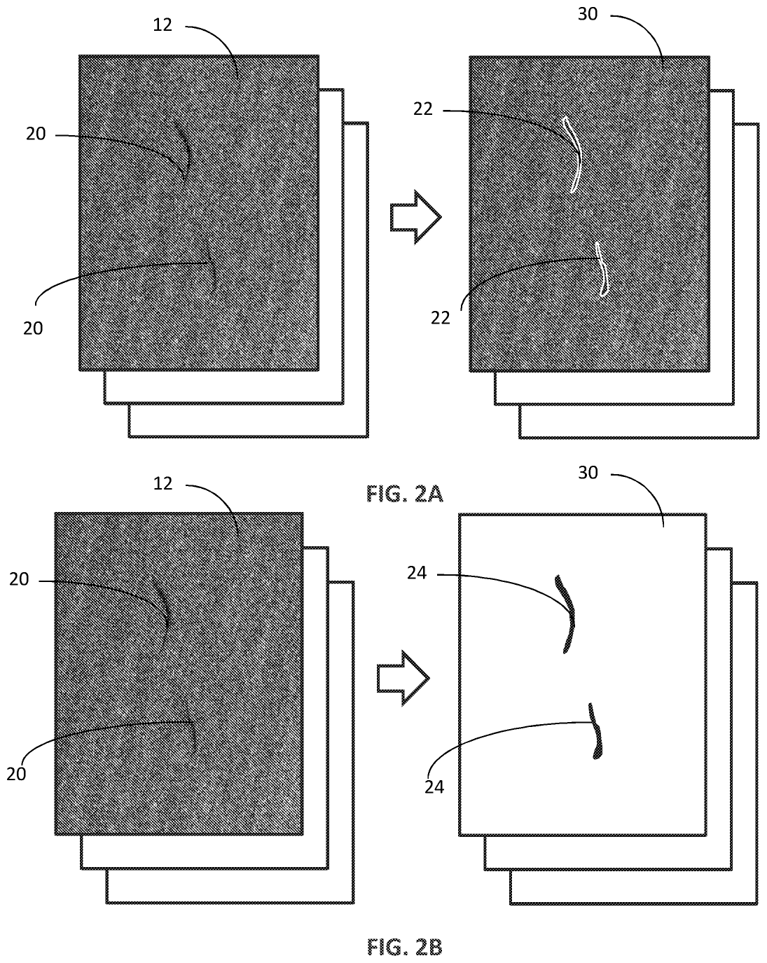

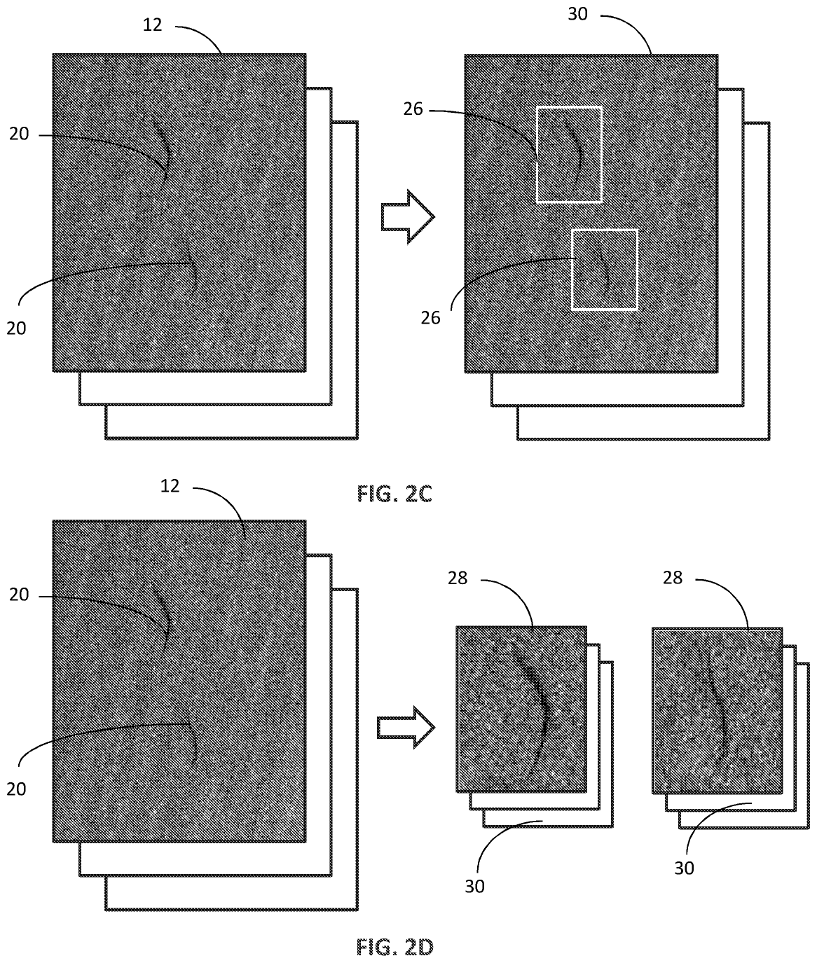

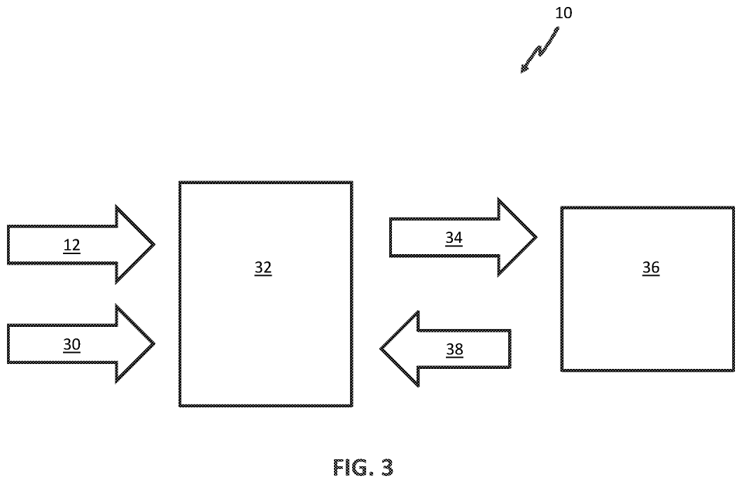

Sea surface anomalies in the initial set of images 12 are labeled such that any pixel(s) defined to be part of a sea surface anomaly are identified. The sea surface anomalies may be labeled by a variety of techniques, including, but not limited to, segmentation, localization, classification, and combinations thereof. Segmentation may include generating a custom-polygon around a spatially contiguous sea surface anomaly and/or labeling pixels. In the embodiment shown in FIGS. 2A and 2B, sea surface anomalies 20 in an initial set of images 12 are labeled by segmentation. In the embodiment of FIG. 2A, the label is a polygon image label 22 in a set of labels 30. In the embodiment of FIG. 2B, the label is an image mask label 24 in a set of labels 30. In another embodiment, the label may be generated by a localization technique to provide a box or other polygon around an entire sea surface anomaly. Box labels 26 in a set of labels 30 are illustrated in FIG. 2C. In the embodiment of FIG. 2D, the sea surface anomalies 12 are cropped and then classified with an image label 28 capturing the sea surface anomaly 20 in a set of labels 30. The cropped image may be further subjected to a segmentation technique, for example.

The set of labels 30 are used to train a model via backpropagation.

Examples of backpropagation-enabled processes include, without limitation, artificial intelligence, machine learning, and deep learning. It will be understood by those skilled in the art that advances in backpropagation-enabled processes continue rapidly. The method of the present invention is expected to be applicable to those advances even if under a different name. Accordingly, the method of the present invention is applicable to the further advances in backpropagation-enabled process, even if not expressly named herein.

A preferred embodiment of a backpropagation-enabled process is a deep learning process, including, but not limited to a convolutional neural network.

As depicted generally in FIG. 3, a preferred embodiment of the training step of the method of the present invention 10 inputs the initial set of images 12 and corresponding set of labels 30 to an untrained algorithm, for example an untrained deep learning algorithm 32. The untrained deep learning algorithm 32 produces a prediction 34 for a sea surface anomaly and is compared in step 36 with the corresponding set of labels 30 from the initial set of images 12. Model parameter adjustments 38 representing any error in the comparison are fed back to the algorithm 32 for updating.

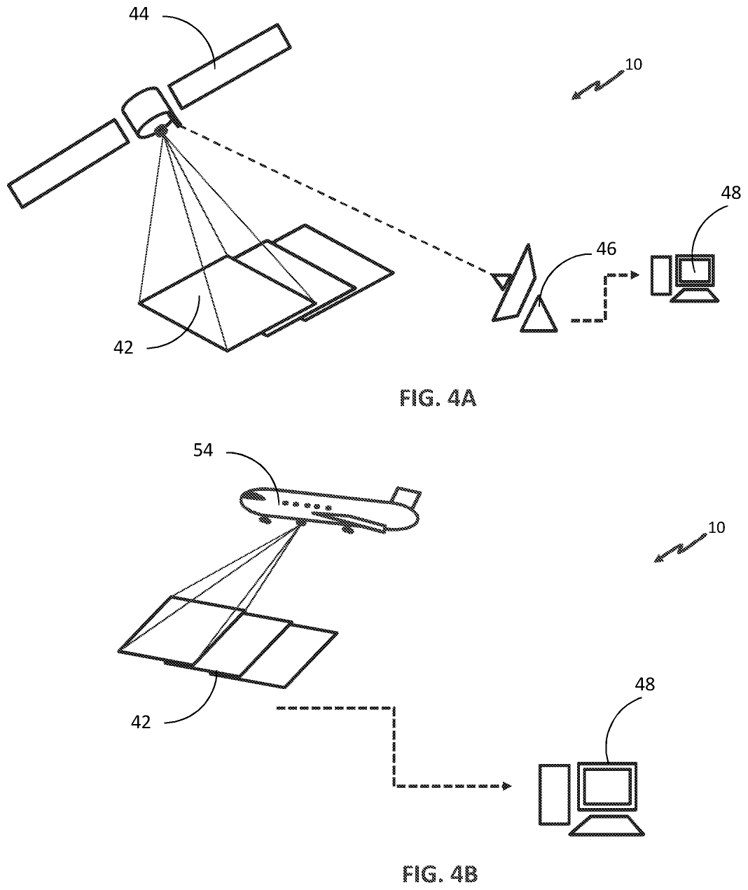

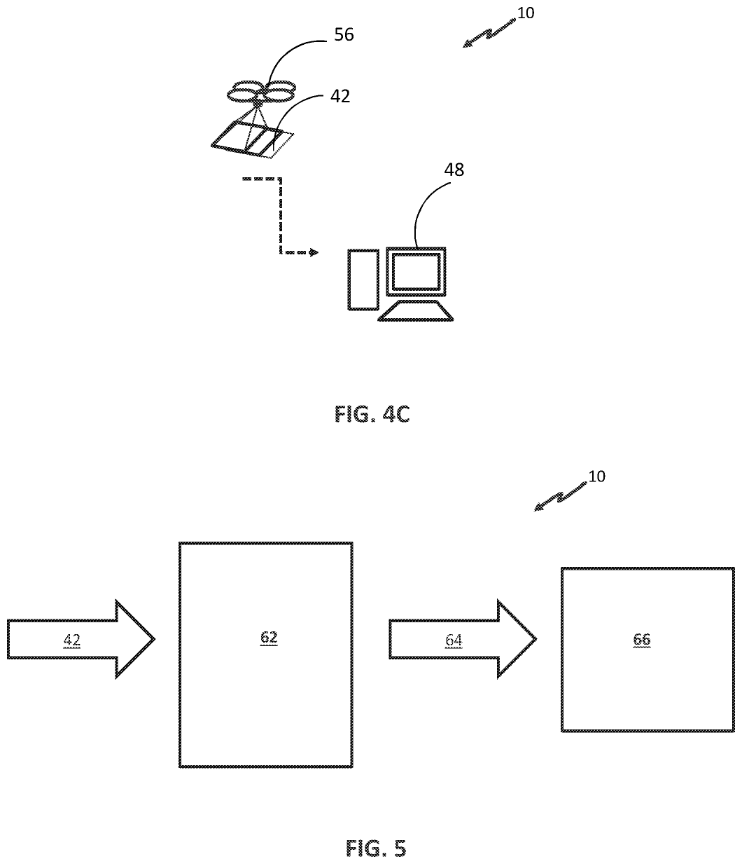

A subsequent set of images 42, illustrated in FIGS. 4A-4C, are collected. The subsequent set of images 42 is selected from the group consisting of satellite-acquired images, airborne-acquired images and combinations thereof.

In one embodiment of the present invention, the subsequent set of images 42 is acquired from a satellite 44 and transmitted through a satellite receiver 46. The satellite 44 and the satellite receiver 46 may each be the same as or different than the satellite 14 and the satellite receiver 46 used in the step of collecting an initial set of images (shown in FIG. 1A).

In another embodiment of the present invention, the subsequent set of images 42 is airborne-acquired. Airborne-acquired images may be acquired using, for example, without limitation, an aircraft 54 (depicted in FIG. 4B) and/or a drone 56 (shown in FIG. 4C).

The subsequent set of images 42 are transmitted to processor 48, depicted generally in FIGS. 4A-4C as a desktop computer. It will be understood by those skilled in the art that the processor 18 may take other forms than a desk-top computer. The processor 48 may be the same or different than the processor 18 illustrated in FIGS. 1A and 1B.

As illustrated in FIG. 5, the trained model 62 is applied to the subsequent set of images 42. The trained model 62 produces a prediction 64 that is used to identify the sea surface anomaly in step 66.

In a preferred embodiment, the position coordinates are determined for the sea surface anomaly. Position coordinates include, for example, without limitation, a global coordinate reference system.

The method of the present invention is particularly suitable for hydrocarbon-based sea surface anomalies. Once identified, hydrocarbon-based sea surface anomalies identified in accordance with the method of the present invention may be used to locate the source of the hydrocarbons potentially suitable for exploitation or remediation.

In a preferred embodiment, the model may be trained to distinguish between types of hydrocarbons by distinguishing features of the sea surface anomaly. In this way, an output of the method of the present invention may include information about the chemical composition of a hydrocarbon-based sea surface anomaly. For example, the model may be trained to distinguish between a crude oil and a refined petroleum.

While preferred embodiments of the present invention have been described, it should be understood that various changes, adaptations and modifications can be made therein within the scope of the invention(s) as claimed below.

1. A backpropagation-enabled method for identifying a sea surface anomaly from satellite-acquired images, airborne-acquired images and combinations thereof, comprising the steps of:
collecting an initial set of images selected from the group consisting of satellite-acquired images, simulated satellite images, and combinations thereof;
labeling the anomaly on the initial set of images;
using the labels to train a model via backpropagation;
collecting a subsequent set of images selected from the group consisting of satellite-acquired, airborne-acquired images, and combinations thereof; and
applying the trained model to identify a sea surface anomaly on the subsequent set of images.

2. The method of claim 1, further comprising the step of determining the position coordinates of the sea surface anomaly.

3. The method of claim 2, wherein the position coordinates refer to a global coordinate reference system.

4. The method of claim 1, wherein the anomaly is caused by hydrocarbon seepage from the subsurface.

5. The method of claim 1, wherein the anomaly is caused by a leak of uncontained hydrocarbons from a man-made facility.

6. The method of claim 4, wherein the seepage is a result of a man-made action.

7. The method of claim 5, wherein the leak is a result of a man-made action.

8. The method of claim 4, wherein the hydrocarbons are crude oil.

9. The method of claim 5, wherein the hydrocarbons are crude oil.

10. The method of claim 1, wherein the sea surface anomaly represents hydrocarbons of a specific chemical composition.

11. The method of claim 1, wherein the step of labeling is performed by a method selected from the group consisting of segmentation, localization, classification, and combinations thereof.
